(19) United States
(12) Patent Application Publication
(10) Pub. No.: US 2014/0143047 A1
(43) Pub. Date: May 22, 2014

(54) Methods and Apparatus for Automated Campaign Generation

(71) Applicants: Jason A. Carter, Lehi, UT (US); Kent McLean, Saratoga Springs, UT (US); Darren R. Noble, Orem, UT (US)

(72) Inventors: Jason A. Carter, Lehi, UT (US); Kent McLean, Saratoga Springs, UT (US); Darren R. Noble, Orem, UT (US)

(21) Appl. No.: 13/223,212

(22) Filed: Aug. 31, 2011

(51) Int. Cl. G06Q 30/00

(52) U.S. Cl. 705/14.49; 705/14.72; 705/14.71

(57) ABSTRACT

Methods and apparatus for various embodiments of an automated campaign generation tool for creating content given one or more sources of data. The campaign generation tool may provide an interface to guide a user through a series of steps by which an automated content generation task is specified and created, such that when the automated content generation task is executed, one or more content objects may be generated in order to be provide to a search engine. By automating the content generation, a user may be able to manage a large and frequently updated source of data.

### BACKGROUND

Large amounts of content intended to be advertised on the internet are created each day, and search engine marketers are often used to manage and optimize search marketing campaigns directed toward advertising that content. Given large and frequently updated streams of content, search engine marketers may quickly become overwhelmed with the burden of producing advertising campaign objects for the many items of content coming in. Further, for any given content source, a search marketer may need to create a large number of varying advertising campaign objects that may be used by a search engine to advertise the content on which the advertising campaign is based.

### SUMMARY

In one embodiment, certain processing steps of an automated campaign generation tool may receive one or more source feeds of structured data and analyze the structured data to determine one or more feed elements from which to generate content. A mapping of feed elements to parameter names may be accessed, where the parameter names are for one or more content generation templates specified for the one or more source feeds. For each specified content generation template, content may be generated based on a given template and also based on data from the structured data according to the mapping for the corresponding template. Once content has been generated, the generated content may be provided to a search engine in order for the search engine to associate the generated content with search results produced by the search engine.

### BRIEF DESCRIPTION OF THE DRAWINGS

FIG. 1 illustrates a module that may automatically generate content from a source feed, according to some embodiments of the automated campaign generation tool.

FIG. 2 is a flowchart of an embodiment of an automated content generation task created through the automated campaign generation tool.

FIG. 3 is a flowchart of an embodiment of the creation of an automated content generation task using a user interface of the automated campaign generation tool.

FIG. 4 depicts an illustration of a user interface for specifying a feed source, according to some embodiments of the automated campaign generation tool.

FIG. 5 depicts an illustration of mapping parameter name values within a user interface, according to some embodiments of the automated campaign generation tool.

FIG. 6 depicts an illustration of a user interface for defining various elements of a template, according to some embodiments of the automated campaign generation tool.

FIG. 7 depicts an illustration of the user interface of FIG. 7, where template values have been entered, according to some embodiments of the automated campaign generation tool.

FIG. 8 depicts an illustration of a user interface window of the automated campaign generation tool for creating an automated content generation task.

FIG. 9 depicts an illustration of a user interface of a job creation window for specifying one or more feed sources and one or more templates, according to some embodiments of the automated campaign generation tool.

FIG. 10 depicts an illustration example feed source data, according to some embodiments of the automated campaign generation tool.

FIG. 11A depicts an illustration of generated content based on the example feed source data of FIG. 10, according to some embodiments of the automated campaign generation tool.

FIG. 11B depicts an illustration of generated content based on the example feed source data of FIG. 10, according to some embodiments of the automated campaign generation tool.

FIG. 12 depicts a computer system suitable for an implementation of the text adjustment tool, according to some embodiments.

While the invention is described herein by way of example for several embodiments and illustrative drawings, those skilled in the art will recognize that the invention is not limited to the embodiments or drawings described. It should be understood that the drawings and detailed description are not intended to limit the invention to the particular forms disclosed, but on the contrary, the intention is to cover all modifications, equivalents and alternatives falling within the spirit and scope of the present invention. The headings used are for organizational purposes only and are not meant to be used to limit the scope of the description. As used throughout this application, the word “may” is used in a permissive sense (meaning “having the potential to”), rather than the mandatory sense (meaning “must”). Similarly, the words “include”, “including”, and “includes” mean “including, but not limited to.”

### DETAILED DESCRIPTION OF EMBODIMENTS

Various embodiments of an automated campaign generation tool may provide automated generation of content such as advertising objects from a given source feed or source feeds. The automated campaign generation tool may provide an interface to guide a user through a series of steps by which a campaign is specified and created, such that when computing jobs created by the campaign are executed, one or more campaign content objects may be generated. By automating the creation of campaign content objects, a user may be able to manage a large and frequently updated source of data because for each update the automated campaign generation tool may automatically create new content reflective of the updated source feed.

In some embodiments, campaign content objects may be directed toward an advertising campaign and created to be compatible with one or more search engines. In the case of an advertising campaign, a generated advertising object may include information regarding an advertisement title, a targeted search engine, a description of the content, automatically generated keywords, and one or more URLs. Advertising objects may be tailored for specific search engines and when provided to a given search engine, the advertising objects may be used by the search engine to display advertising information alongside a display of search query results.

In other embodiments, the content generated by the automated campaign generation tool may be targeted for non-marketing purposes, such as ad exchanges or ad serving services. In other examples, the automated campaign generation tool may create content that is compatible with the application programming interface (API) of any other application or process making use of the transformation by the automated campaign generation tool of structured data from one or more source feeds into new content. As described within this application, in some embodiments, the periodic or aperiodic creation of new content is based on the structured data from one or more sources, mappings of the structured data to parameter names, and template specifications for manipulating the structured data through the use of the parameter names.

In some embodiments, the generated content may be submitted to a user for approval prior to being provided to another application. In other embodiments, the entire process, from receiving structured data to generating and providing content, is performed automatically without any user intervention.

In the following detailed description, numerous details are set forth to provide a thorough understanding of the claimed subject matter. However, it will be understood by those skilled in the art that the claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining”, or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

### Example Embodiment

### Automated Content Generator

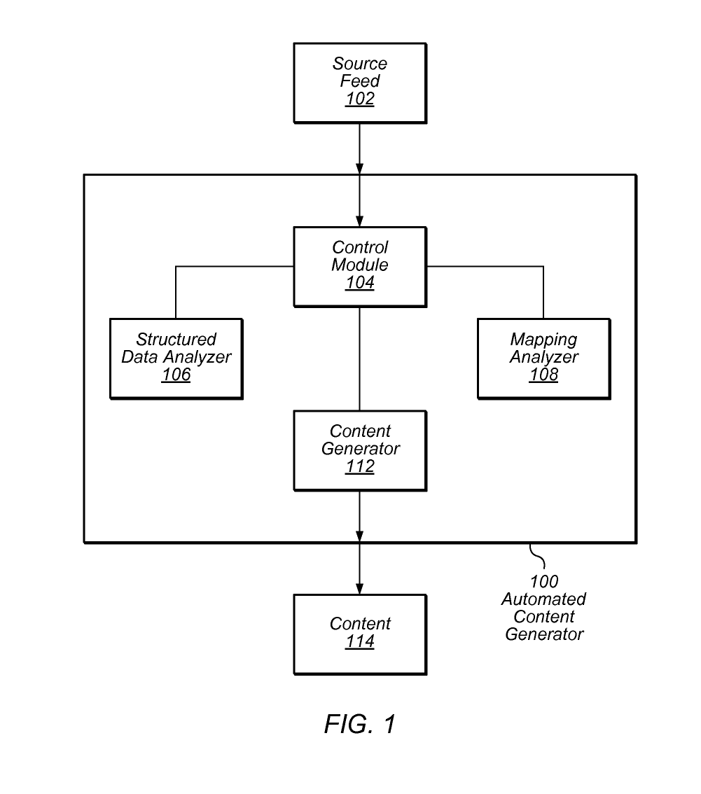

FIG. 1 illustrates an embodiment of certain modules of an Automated Content Generator 100, as operable within an automated campaign generation tool. Prior to the execution of the Automated Content Generator 100, a user may specify characteristics of how the automated campaign generation tool may define one or more automated content generation tasks, or jobs, for creating content given one or more source feeds of structured data. Upon receiving input necessary for creating an automated content generation task, or automated job, the automated campaign generation tool may invoke Automated Content Generator 100 to generate content according to the specifications of the automated content generation task.

Given source feed 102, the Automated Content Generator 100 may generate new content. Source feed 102 may be any type of structured data from which a user may wish to generate content appropriate for use by a search engine. Further, source feed 102 may be structured data from one or more sources. The generated content 114 may be used by various third party search engines in order to present a user of a given search engine with advertisements in response to a user query.

Upon receiving source feed 102, Control Module 104 may, using Structured Data Analyzer 106, analyze the structured data within the source feed to determine one or more feed elements from which to generate content. Source feed 102 may be an XML file, a spreadsheet with comma separated values, or any other type of file with a defined structure from which a field name and a corresponding data value for the field name may be extracted.

Given a determination of feed elements, Control Module 104 may, using Mapping Analyzer 108, access and analyze mapping information defining a mapping of feed elements to parameter names for one or more content generation templates. In some embodiments, the mapping information may be stored within the runtime memory of the automated content generation task or automated campaign generation tool. In other embodiments, the mapping information may be stored in a file within a local or remote file system.

Content Generator 112 may, for each specified content generation template, generate content based on a given template and based on data from the structured data according to the mapping information for the given template or templates.

Generated content 114 may then be provided, for example, to a search engine for the search engine to associate the generated content with search results produced by a given search query.

Each of the modules within Automated Content Generator 100 may be implemented by program instructions stored in a computer-readable storage medium and executable by one or more processors. Other embodiments of the modules within the text adjustment tool may be at least partially implemented by hardware circuitry or firmware within one or more processors.

### Example Embodiment

### Automated Content Generation Task

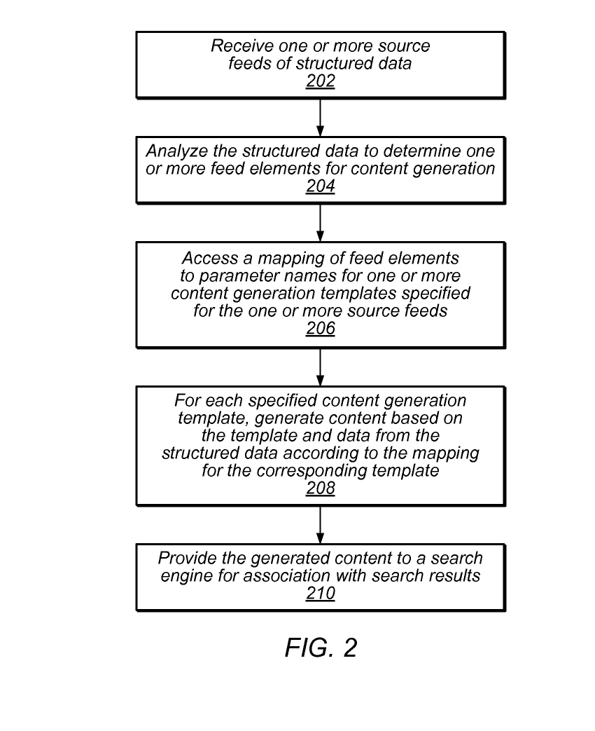

FIG. 2 illustrates a flowchart highlighting certain processing steps that may be present in an embodiment of an automated content generation task created by an automated campaign generation tool. Upon the creation and execution of the automated content generation task, structured data may be received from one or more source feeds. The content provided by a source feed may be any type of information from which an advertisement may be created for display by a search engine in response to a user search query.

A source feed may be from, for example, a news organization or an online vendor. In some embodiments, the source feed may be either an RSS feed or an uploaded file. The format of the source feed may be XML, however, any format capable of distinguishing field names from field name data may be considered structured data and may serve equally well. In one example, an RSS feed may be from an online vendor and the source feed data may pertain to a high-definition television. In other examples, the source feed may provide spreadsheet data, or equivalent comma separated values. In other examples, the source feed may be received via an upload of a file via a local file system or remotely via FTP. Further, for a given automated content generation task, one or more source feeds may be specified. Step 202 depicts the automated content generation task receiving one or more source feeds of structured data.

Given the receiving of the structured data, the automated content generation task may perform an analysis of the structured data, as in step 204. One feed element of the structured data may be a title, and given the title feed element, the automated content generation task may determine data associated with the title. In the case the source feed is from a vendor of televisions, the data associated with the title may be a manufacturer name and specifications regarding the television, such as screen size and screen type. The title is only one possible feed element, another feed element may relate to a URL from which a user may purchase the television, another feed element may relate to description of the television, and so on.

During the creation of the automated content generation task via the automated campaign generation tool, a mapping of feed elements to parameter names may have been performed when a feed source was specified. For example, for a given feed element, such as “title”, a user may provide an identifying parameter name such as “my_title.” Given one or more associations, or mappings, of parameter names to feed elements, a user may later use the parameter names when defining template values.

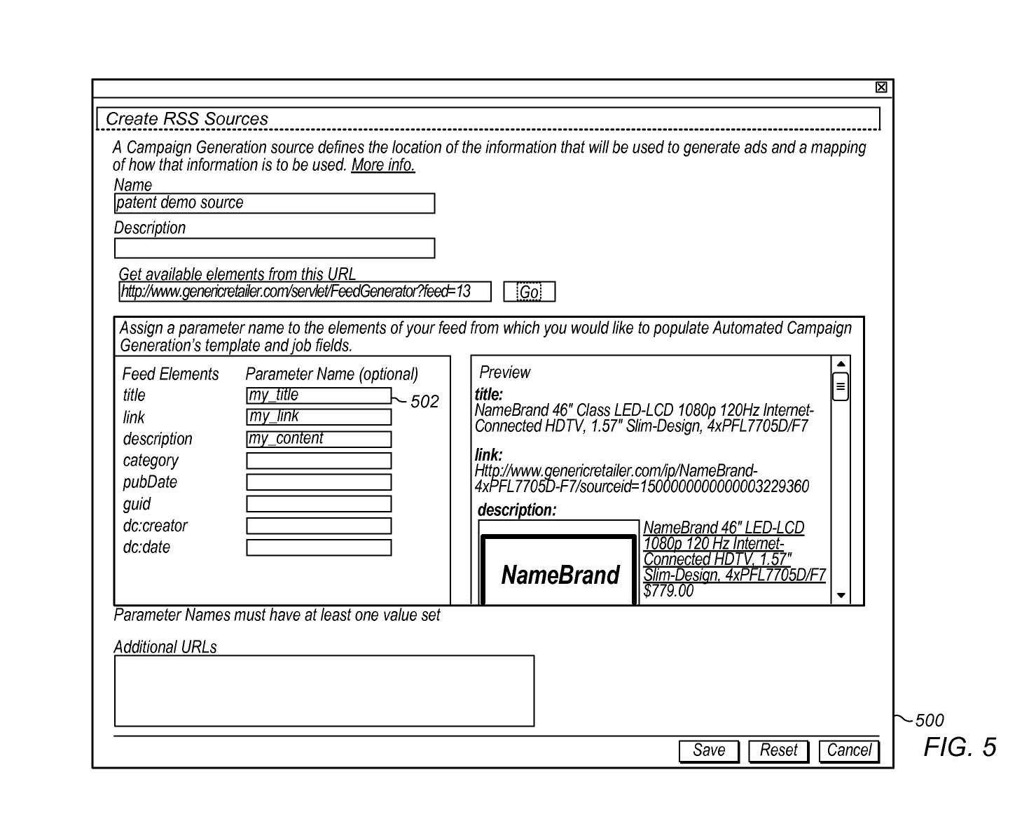

A template provides a user with a method for accessing feed elements in order to create template values via the association of a feed element to a parameter name. Further, a parameter name may be mapped to one or more feed source elements. In this way, for sources with feed elements having different feed element names, when specifying template values, a user may refer to a single defined parameter name and still be able to make use of multiple, differently named feed elements. For example, one source feed may specify a title of the source feed as “title”, while a different source feed may specify a title of the source feed as “headline.” In this case, a user may specify a parameter name of “my_title” to be defined for the “title” feed element of the first source feed and “my_title” to be defined for the “headline” feed element of the second source feed. In this way, when a user is specifying template values, the user may refer simply to “my_title” in order to access data associated with either “title” of the first source feed or “headline” of the second source feed. An example of defining a parameter name is depicted in FIG. 5.

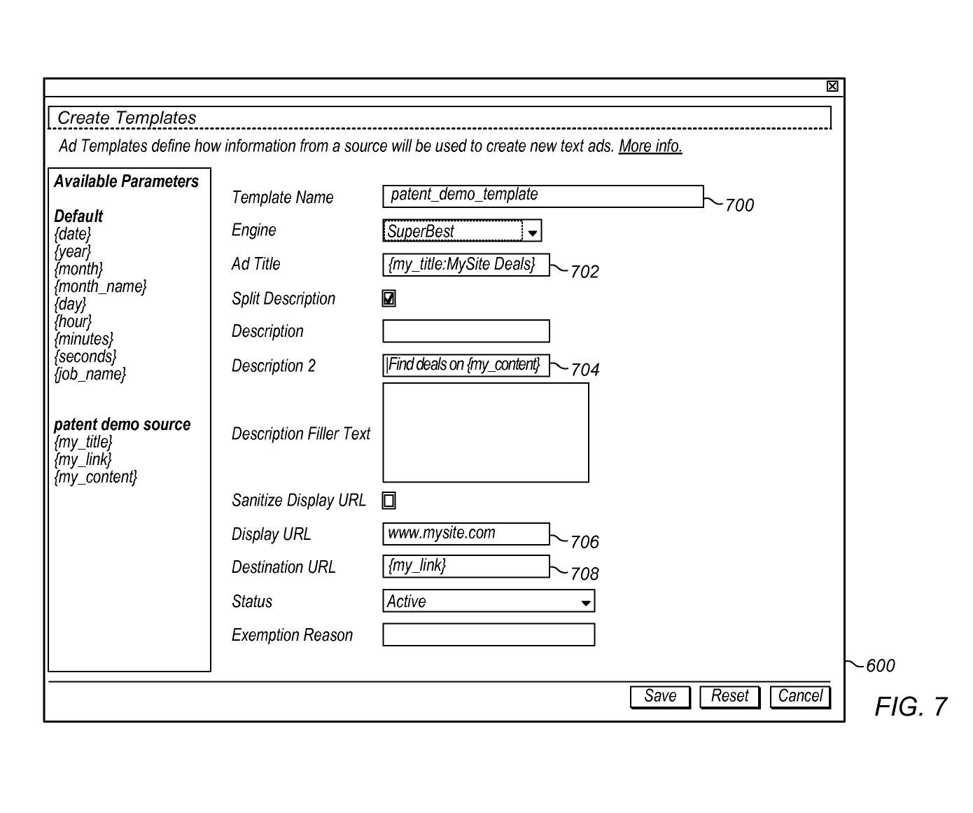

The automated campaign generation tool allows a user to specify one or more values within a template field within the automated campaign generation tool user interface. An example of specifying a template field is depicted in FIG. 7. For a given template field, such as “Ad Title” a user may enter either one or more fixed values, one or more dynamic parameters, or a combination of one or more fixed values and dynamic parameters. As would be expected, when the automated content generation task is creating new content, any fixed values defined for the “Ad Title” field of the template are reproduced when the new content is created.

Dynamic parameters, unlike fixed values, are not merely reproduced by the automated content generation task. Dynamic parameters may provide either variables such as parameter names, or the dynamic parameters may provide instructions to be interpreted at execution time of the automated content generation task. A dynamic parameter may be delimited by curly brackets and take the form of {value:default-value}, where a colon separates a value and default value. Dynamic parameters may be entered into a template field via the user interface of the automated campaign generation tool during the definition of a template. As an example, during the specification of the template “patent_demo_template” in FIG. 7, the template field for “Ad Title” is specified to be {my_title:MySite Deals}. Given the earlier association of parameter name “my_title” with feed source element “title”, when the automated content generation task is creating the new content, the “Ad Title” portion of the new content may be defined to be any data associated with the “title” feed element of the source feed. In the case that there is no data associated with the “title” feed element of the source feed, the automated content generation task may define the content for “Ad Title” to be the default value of the dynamic parameter, or “MySite Deals.” Alternatively, the dynamic parameter in this example may be defined to be {my_title}, in which case no default value is substituted during content creation in the case that there is no associated data for the “title” feed element.

Once parameter names are defined, they may be used for any template field of the template definition window of the automated campaign generation tool. For example, given the above defined “my_title” parameter name, in addition to being used to define content for the “Ad Title” portion of the new content, the “my_title” parameter name may be used to define content for the “Description” portion of the new content, or for any other template field. The same parameter name may also be used multiple times within the same template field.

During execution of the automated content generation task, given one or more source feeds, a mapping of feed elements to parameter names is performed, as in step 206. For a given template associated with the one or more source feeds, for each template field value defined, the automated content generation task may create an element of the new content. Each new element of the new content depends on whether the template field value was defined to be a fixed value, a dynamic parameter, or a combination of both. Once the given template processes each template field value defined, a new content object may be considered completed and fully specified. The execution of the automated content generation task may repeat the process of creating new content for each template associated with the one or more source feeds, as in step 208.

Once each template associated with the one or more received source feeds is processed by the automated content generation task, one or more new content objects may have been created. These one or more new content objects may then be provided to a search engine for association with search results, as in step 210. The search engine for which the new content is compatible depends on the search engine specified as the target during the creation of the automated content generation task. In this way, when a user enters a search query, the search engine has access to a new content object produced by the automated content generation task that is in a compatible and readable format for the given search engine.

### Example Embodiment

### Creating an Automated Content Generation Task

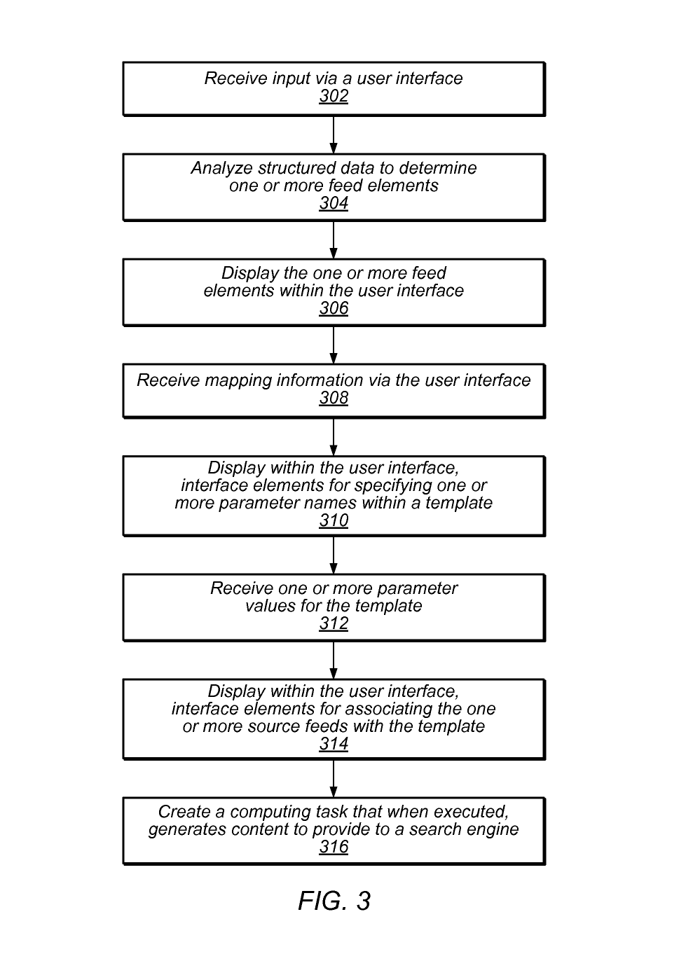

FIG. 3 illustrates a flowchart highlighting certain processing steps that may be present in an embodiment of an automated campaign generation tool. The automated campaign generation tool may provide a user interface through which an automated content generation task may be created. As discussed above with respect to FIG. 2, execution of an automated campaign generation task may receive source feed structured data and produce content to be provided to a search engine to be displayed alongside search query results.

In order to create an automated content generation task, a user may specify, the automated campaign generation tool user interface, at least: (1) mapping source feed elements to parameter names, (2) creating one or more templates, and (3) creating a job by specifying one or more source feeds and one or more template values. As used within this application, a job is synonymous with an automated content generation task.

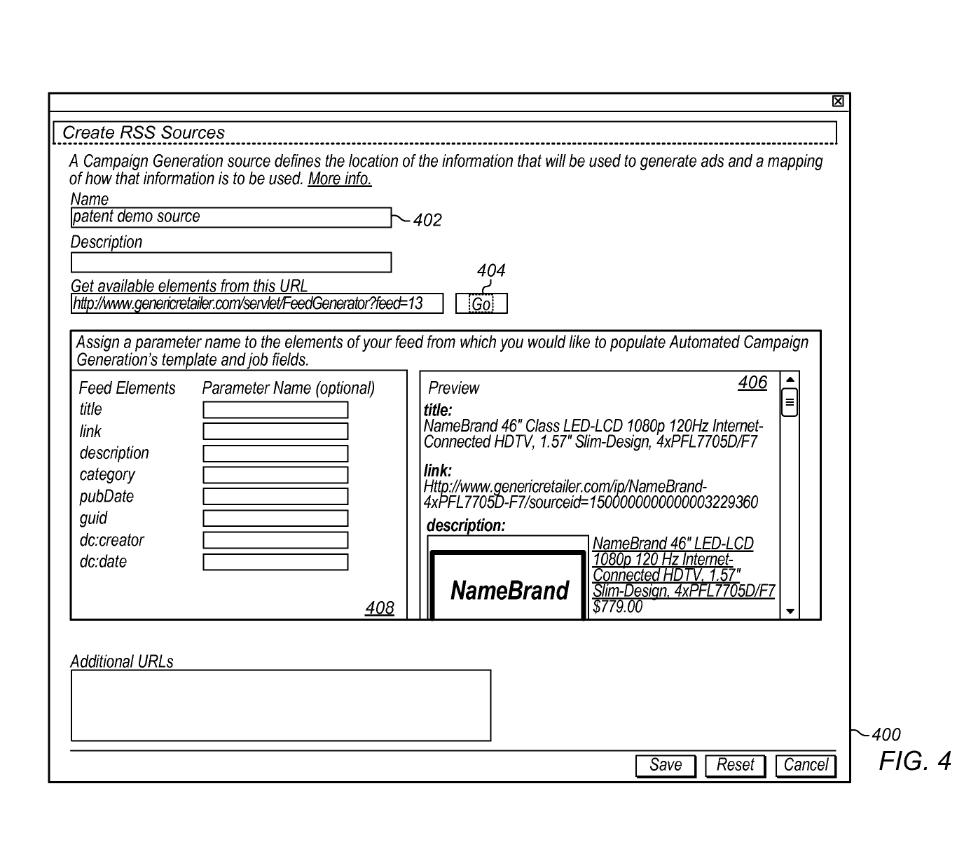

FIG. 4 illustrates a user interface window 400 of the automated campaign generation tool through which a source feed may be specified and named, as depicted by name element 402. In this example, an RSS source is specified, however, as discussed above, a variety of sources may be specified. The receiving of user input via user interface window 400 specifying the source feed 404 corresponds to step 302 of FIG. 3, indicating receiving input via a user interface.

Further depicted within FIG. 4 is a preview panel 406, displaying a source feed element followed by a display of information associated with that source feed element. For example, within preview panel 406, a “title” source feed element is displayed, and underneath “title” is displayed title information including a brand name and other details pertinent to the given product. To display the information within the preview panel 406, the automated campaign generation tool analyzes the source feed and the structure of the source feed to identify the various feed elements, as in step 304 of FIG. 3.

Once the source feed has been analyzed, the automated campaign generation tool may display the contents of the preview panel 404, including each feed element and information associated with the given feed element, as in step 306 of FIG. 3. In addition to the preview panel 404, the automated campaign generation tool may display a list of feed elements next to an entry field through which a user may enter a parameter name for the feed element. This list of feed elements is depicted in feed elements panel 408.

Given the list of feed elements, using feed elements panel 408, a user may enter a parameter name for a given feed element, as depicted by element 502 of FIG. 5 where the feed element “title” is mapped to parameter name “my_title.” Each feed element source may be mapped to a user-defined parameter name. The receiving of the mapping information for the feed elements to parameter names by the automated campaign generation tool is indicated by step 308 of FIG. 3.

As each parameter name is entered by a user, the automated campaign generation tool displays the parameter name alongside the feed element, as indicated by step 310 of FIG. 3 and as depicted by element 502 of FIG. 5. When a user has completed mapping parameter names to feed elements, the set of associations between feed elements and parameter names may be considered the mapping information for the given source feed. At this point, a source feed is usable by the automated campaign generation tool for creating automated content generation tasks, or jobs.

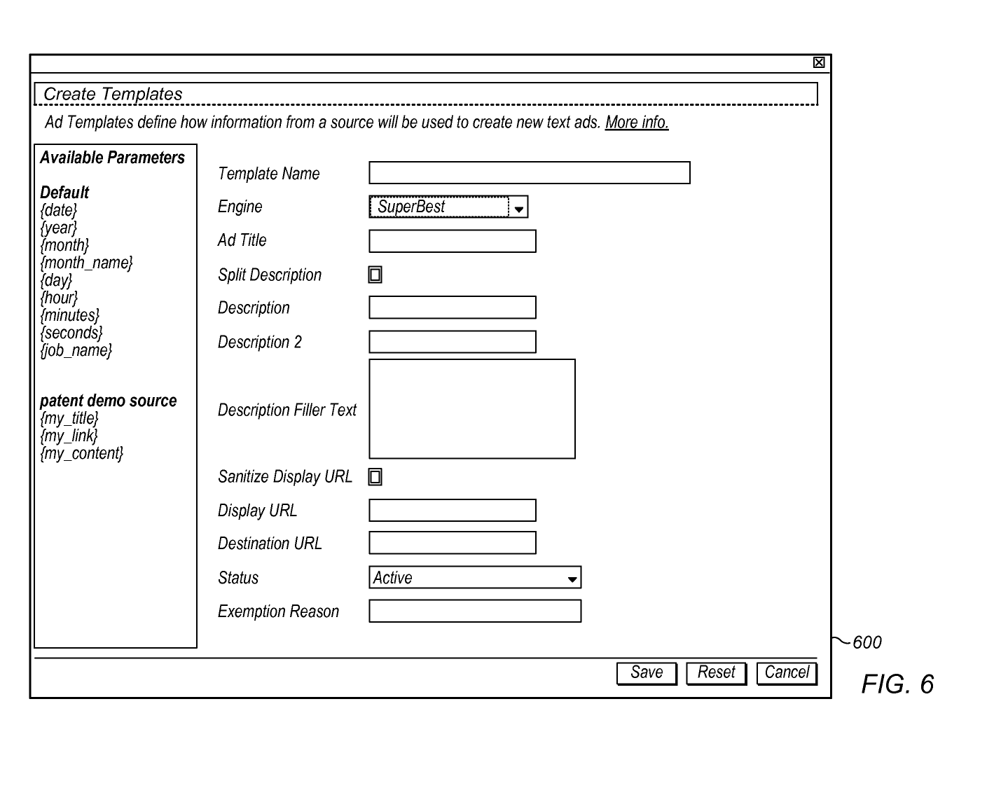

FIG. 6 depicts a template creation window 600 in which a user has specified that the template being created is to generate content targeted to a fictional SuperBest search engine. However, in other examples, the generated content may be targeted to be compatible for any local or third party search engine. In yet other examples, generated content may be tailored to be compatible with the application programming interface (API) of any software application making use of the generated content.

FIG. 7 depicts template creation window 600 with additional template values specified, where the receiving of each of the template values is reflected by step 312 of FIG. 3. As depicted by element 700, the example template is named “patent_demo_template.” When the automated content generation task executes, one of the content values generated may by the “Ad Title” content, where at execution time, the automated generation task may determine the content to create for “Ad Title” by the specified template value of {my_title:MySite Deals}, as depicted by element 702. As described above, “my_title” has been mapped to a source feed element “title.” When the automated content generation task executes, upon receiving source feed structured data, the automated content generation task may use mapping information to identify data associated with the “title” feed element of the source in order to generate the “Ad Title” data of the generated content. In this template value example, a default value has been specified, “MySite Deals”, which in case the source feed does not have any data for the “title” feed element mapped to the “my_title” parameter name, the automated content generation task may use “MySite Deals” in order to create the generated content.

As depicted by element 704 of the template creation window 600, for the generated content associated with “Description”, the automated content generation task may interpret the mix of fixed data values and a parameter name. In this case, the automated content generation task may create “Description” data for the generated content that in every case would include “Find deals on” text data. Further in this case, the automated content generation task may create, following “Find deals on”, followed by whatever feed element has been mapped to “my_content.” Note that there is a space character after “Find deals on”, as in this case, whatever information results from resolving the value of “my_content” may be concatenated to “Find deals on.” In this example, there is no default value specified in the case that “my_content” resolves to an empty structured data field value, as indicated by no colon following the specification of “my_content.”

Similarly to specifications depicted by elements 702 and 704, element 706 depicts a hard data value of “www.mysite.com”, which may be reproduced exactly by the automated content generation task. Element 708 depicts “Destination URL” content for the generated content, and the automated content generation task may replace “my_link” with the feed element value reached via the mapping of the feed element value to parameter name “my_link”, and in the case that there is no such feed element value, no content is generated for this field of the generated content.

The display of each of these template values within template creation window 600, is reflected by step 314 of FIG. 3.

At this point, the automated campaign generation tool has been used to specify a source feed and mapping, and a template and template values. Now, given the definition an automated content generation task making use of the source feed and template, the automated campaign generation tool may create the automated content generation task.

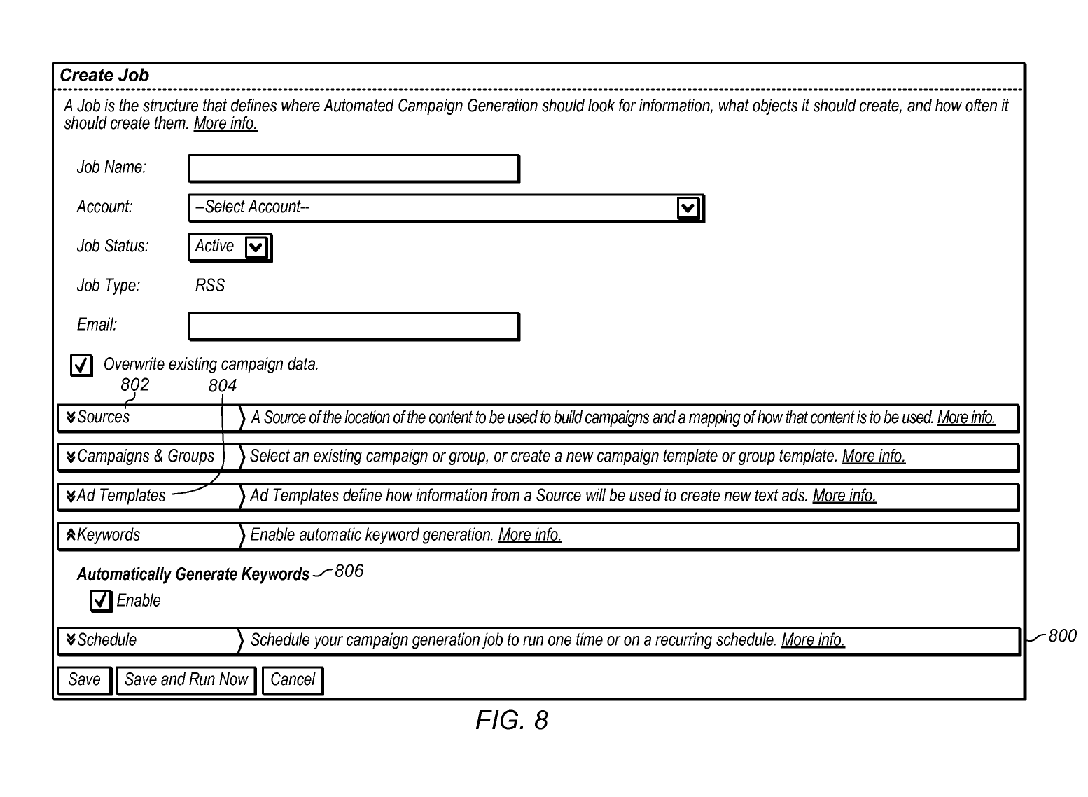

FIG. 8 illustrates a “Create Job” window 800 from which a user may specify one or more sources for a job and one or more templates to use, in addition to specifying a schedule on which the job is to be executed, and various other aspects of the job. Create job window 800 includes user interface elements for specifying sources 802, and specifying templates 804.

When user interface element 802 is expanded, a user is presented with the options depicted by user interface panel 902. User interface panel 902 allows a user to select from one or more sources of source feeds, and as depicted, the above discussed example, “patent demo source” has been selected. Additional sources may be selected.

When user interface element 804 is expanded, a user is presented with the options depicted by user interface panel 904. User interface panel 904 allows a user to select from one or more templates, and as depicted, the above discussed example, “patent_demo_template” has been selected. Additional templates may be selected.

Given the earlier mappings of feed source elements to parameter names, and the specification of template values, a user may now create an automated content generation task by clicking the “Save” button of the create job window 800. The creation of the job, or automated content generation task, is reflected by step 316 of FIG. 3. Step 316 further indicates that upon execution of the automated content generation task, content may be created, which may then be provided to the specified search engine.

### Example Embodiment

### Automatically Generating Content

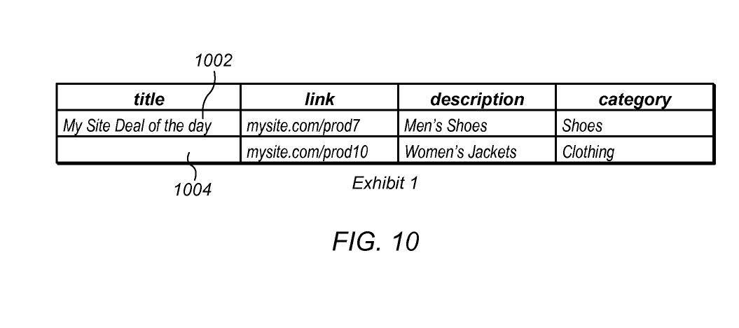

Given the creation of an automated content generation task, as described above with respect to FIG. 3, an executing automated content generation task may now generate content automatically for each source feed update received. FIG. 10 illustrates simplified example source feed information with “title”, “link”, “description”, and “category” feed elements. FIG. 10 illustrates two source feed updates.

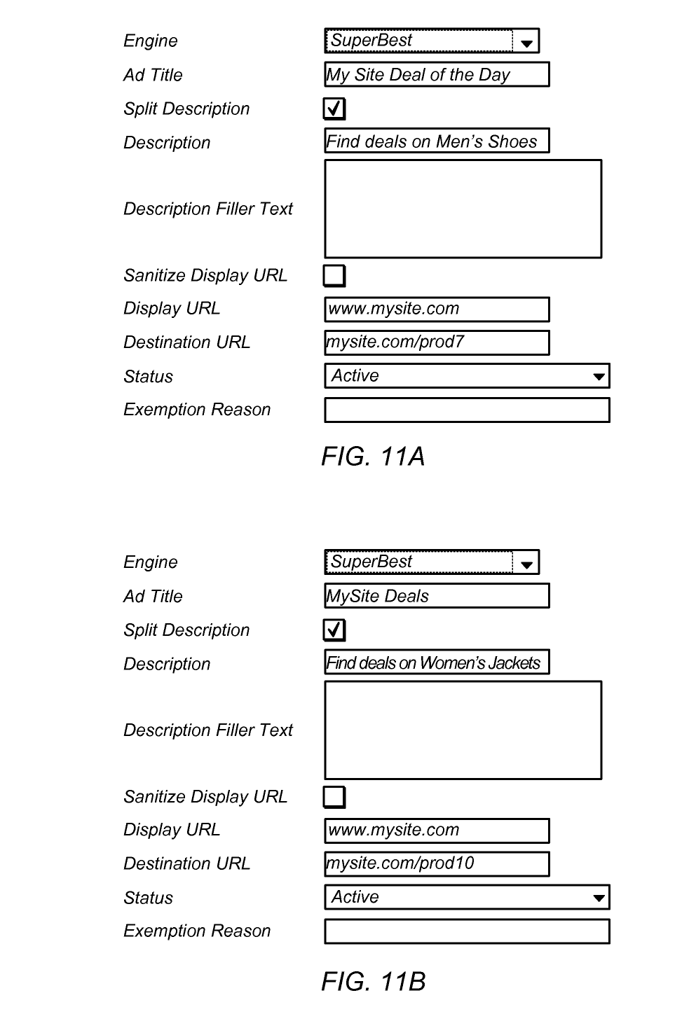

Given the source feed information in table 1000, and the earlier specified “patent_demo_template” and “patent demo source”, an automated content generation task may produce the content illustrated in FIGS. 11A and 11B.

Regarding generated content 1102, as described earlier with respect to the “Ad Title” content field to be generated, the “patent_demo_template” specifies that to generate the “Ad Title” content, parameter value {my_title:MySite Deals} is to be interpreted, as indicated by element 702 of FIG. 7. For the first source feed update, depicted by element 1002, the title is “My Site Deal of the Day”, which maps to parameter name “my_title”, and since the automated content generation task may determine that “my_title” resolves to a value in the source feed, the automated content generation task may create “Ad Title” content “My Site Deal of the Day”, and default value “MySite Deals” may go unused. The remaining source feed elements, “link”, “description”, and “category” are similarly processed by the automated content generation task in order to create content 1102.

Regarding generated content 1104, the automated content generated task uses source feed update 1004 on which to base the generated content. In contrast to the generation of the “Ad Title” content for source feed 1002, source feed 1004 does not specify any “title” information for the source feed. In this case, when interpreting template value {my_title:MySite Deals}, the automated content generation task determines that “my_title” resolves to no data values, and proceeds to use the default data, “MySite Deals”, as reflected in generated “Ad Title” content of content 1104. The remaining content elements of content 1104, are similarly processed using the remaining feed elements “link”, “description”, and “category.”

### Example Embodiment

### Multiplicative Content Generation

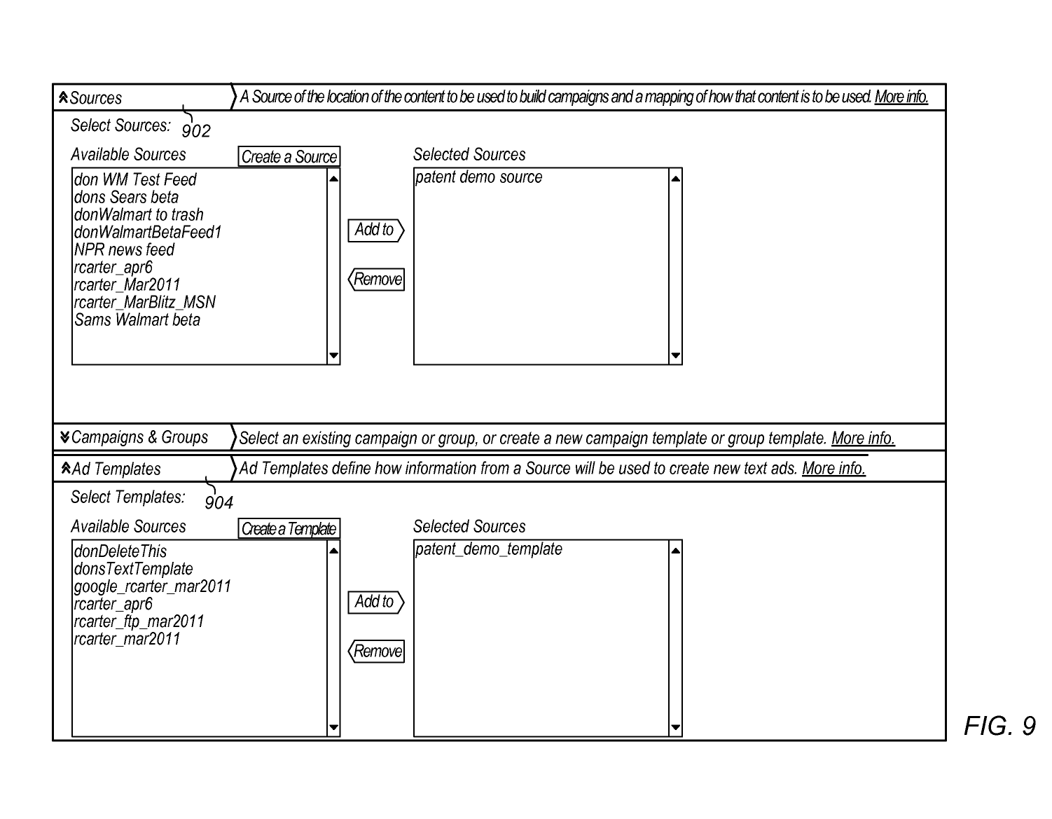

In the example automated content generation task defined above with respect to FIGS. 8 and 9, one source feed and one template were used in determining generated content. However, a user may also introduce a second template to be processed by the same automated content generation task being defined. For example, in addition to specifying that “patent_demo_template” be selected, a user may also have specified that a second template be specified, such as “rcarter_apr6.”

Given two templates to process for a given source feed update, source “patent demo source” in this example, instead of two content objects being created, as depicted by FIGS. 11A and 11B, four content objects may be created. In other words, processing of template “patent_demo_template” would proceed as described above, however, after the “patent_demo_template” has been processed by the automated content generation task, the same source feed data is applied to the second template, creating an additional content object. After the second source feed update, there may be a total of four new content objects. In a similar fashion, for each template added to the specification of the automated content generation task, any received source feed structured data may be processed.

Similarly, if additional source feeds are specified for a given automated content generation task, the structured data from each source feed is process by each specified template of the automated content generation task. For example, given a single template as above, “patent_demo_template”, with two source feeds, each providing two updates of structured data, the result would be four generated content objects.

Similar multiplicative results are gained if a single automated content generation task is specified to have m source feeds, and n templates, in which case, for each source feed update from the combined source feeds, n*m content object may be created by the automated content generation task.

The ease with which additional templates may be added to the specification of an automated content generation task allows a user to create similar, but differently targeted content objects. For example, two templates may be similarly defined, however, one template may specify a parameter value for “Ad Title” of “End of summer sale! {my_title}”, and another template may specify the same parameter value of “No holds barred summer blowout!”, in which case the generated content may be similar except for the ad title. In this way, a marketer may experiment to determine the most effective language to use, and the only extra effort to creating a complete extra set of content similar to other content is to specify an additional template.

### Example Embodiment

### Quality Control for Generated Content

In addition to generating content, an automated content generation task may perform various quality and correctness checks before providing the generated content to a search engine. In some embodiments, an automated content generation task may attempt to load a destination URL specified within the generated content, and in the case that the destination URL fails to load, the automated content generation task may determine not to provide the generated content to a search engine. In this case, the determination that a destination URL fails to load may be based on an error message returned upon attempted loading of the web page or a timeout.

In other embodiments, the automated content generation task may perform a quality check of the destination URL web page. For example, when the content generation task is being defined via the automated content generation campaign tool, a user may specify that keywords also be automatically generated for the generated content. This specification of keywords being generated may be accomplished by a user checking an enable box within a “Keywords” panel of the create job window 800, as depicted by element 806 of FIG. 8. In this case, if there is no overlap between the keywords generated by the automated content generation task and the keywords associated with the destination URL web page, the automated content generation task may determine not to provide the generated content to a search engine or a user may be provided with a warning. In other embodiments, a user-defined threshold for keyword overlap, or keyword quality may be used to specify a tolerance for lack of overlap between the generated keywords and the keywords of the destination URL web page. In this case, if the threshold for keyword overlap is not met, then the automated content generation task may determine not to provide the generated content to a search engine or to provide a warning.

### Example Embodiment

### Dynamic Parameters

Dynamic parameters were introduced above with respect to FIG. 5, and also with respect to the execution of an automated content generation task as in FIG. 2. Discussed was the option provided to a user to specify a parameter value of a template with fixed data, a dynamic parameter, or a combination of both. The above discussed dynamic parameters had only the format of {value:default-value} or {value}. However, in other embodiments of the automated campaign generation tool, additional dynamic parameter options are available.

As depicted within FIG. 7, additional parameters may be available that are not related to or mapped to source feed elements. For example, when defining a template value for “Ad Title”, a user may specify, “{month} Specials!”, in which case, in whatever month the content is generated by the automated content generation task, the ad title of the content specify “August Specials!”, in the case the current month is August. In this way, if a user would like to vary their ad titles month by month, there is no need to redefine the underlying template.

In other embodiments, instead of simply varying the month name by using {month} within the “Ad Title” template value, a user may specify conditional content. For example, if a user creates an automated content generation task in August, and the user would like for discounts of 20% to apply in August, and 40% discounts to kick in come September, a user may specify within the template parameter value, “{{month}==“August”: 20% off everything!} {{month} “September”: 40% off entire inventory!}“, in which case, when the automated content generation task is executing, it may determine the month is August, and generate content for “20% off everything!” based on the first dynamic parameter, and because for the second dynamic parameter the month does not equal September, the second dynamic parameter resolves to nothing.

In other examples, the automated content generation task may calculate mathematical expressions defined by a dynamic parameter. For example, if a user would like to increase the price of a product by an additional 10% over the price specified by a price feed element, the user may specify the “Ad Title” parameter value to be, “{category} for only {my_price+(0.1*my_price)}!”, in which case the user may wish to redirect the user to a URL, which is different from a source feed destination URL, from which the user may purchase the product at the increased price. In this example, “category” has been mapped to a category feed element and “my_price” has been mapped to a price feed element.

Dynamic parameters may also be used to direct the automated content generation task to perform actions unrelated to the generation of content. For example, a template parameter value may be specified indicating that an advertising campaign is to end in 10 days. In such an example, a user may specify {day+10} within a parameter name value directed to expiration days. Other examples of pre-defined dynamic parameters are {date}, {year}, {month}, {month name}, {hour}, {minutes}, {seconds}, and {job name}. In other embodiments, a user may define additional dynamic parameters.

### Example Computer System

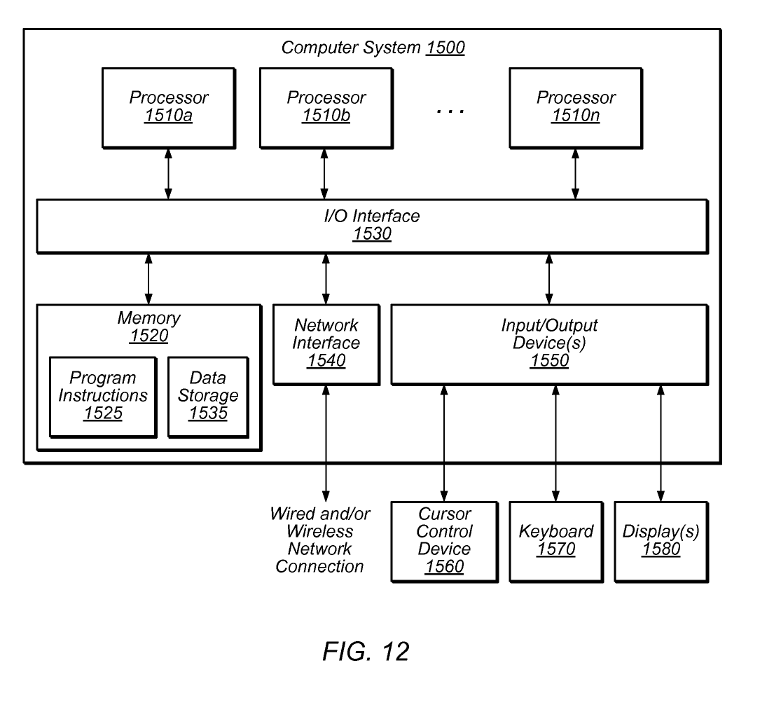

FIG. 12 illustrates a computer system 1500 that may execute embodiments of an automated campaign generation system. In different embodiments, the computer system may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a television, a video recording device, a peripheral device such as a switch, modem, router, or in general any type of computing or electronic device.

In one embodiment, the computer system includes one or more processors coupled to a system memory via an input/output (I/O) interface. The computer system further includes a network interface coupled to an I/O interface, and one or more input/output devices, such as a cursor control device, a keyboard, and display(s). In some embodiments, it is contemplated that embodiments may be implemented using a single instance of a computer system, while in other embodiments may be implemented on multiple such systems, or multiple nodes making up a computer system, may be configured to host different portions or instances of embodiments. For example, in one embodiment some elements may be implemented via one or more nodes of the computer system that are distinct from those nodes implementing other elements.

In various embodiments, the computer system may be a uniprocessor system including one processor, or a multiprocessor system including several processors (e.g., two, four, eight, or another suitable number). The processors may be any suitable processor capable of executing instructions. For example, in various embodiments, the processors may be general-purpose or embedded processors implementing any of a variety of instruction set architectures (ISAs), such as the x86, PowerPC, SPARC, or MIPS ISAs, or any other suitable ISA. In multiprocessor systems, each of processors may commonly, but not necessarily, implement the same ISA.

In some embodiments, at least one processor may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the content object processing methods disclosed herein may, at least in part, be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory within the computer system may be configured to store program instructions and/or data accessible by a processor. In various embodiments, the system memory may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of an automated campaign generation system are shown stored within system memory as program instructions and data storage, respectively. In other embodiments, program instructions and/or data may be received, sent or stored upon different types of computer-accessible media or on similar media separate from system memory or the computer system. Generally, a computer-accessible medium may include storage media or memory media such as magnetic or optical media, e.g., disk or CD/DVD-ROM coupled to the computer system via the I/O interface. Program instructions and data stored via a computer-accessible medium may be transmitted by transmission media or signals such as electrical, electromagnetic, or digital signals, which may be conveyed via a communication medium such as a network and/or a wireless link, such as may be implemented via the network interface.

In one embodiment, the I/O interface may be configured to coordinate I/O traffic between the processor, the system memory, and any peripheral devices in the device, including a network interface or other peripheral interfaces, such as input/output devices. In some embodiments, the I/O interface may perform any necessary protocol, timing or other data transformations to convert data signals from one component into a format suitable for use by another component. In some embodiments, the I/O interface may include support for devices attached through various types of peripheral buses, such as a variant of the Peripheral Component Interconnect (PCI) bus standard or the Universal Serial Bus (USB) standard, for example. In some embodiments, the function of the I/O interface may be split into two or more separate components, such as a north bridge and a south bridge, for example. In addition, in some embodiments some or all of the functionality of the I/O interface, such as an interface to system memory, may be incorporated directly into the processor.

The network interface of the computer system may be configured to allow data to be exchanged between the computer system and other devices attached to a network, such as other computer systems, or between nodes of the computer system. In various embodiments, the network interface may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

The I/O devices may, in some embodiments, include one or more display terminals, keyboards, keypads, touchpads, scanning devices, voice or optical recognition devices, or any other devices suitable for entering or retrieving data by one or more computer systems. Multiple I/O devices may be present in the computer system or may be distributed on various nodes of the computer system. In some embodiments, similar I/O devices may be separate from the computer system and may interact with one or more nodes of the computer system through a wired or wireless connection, such as over the network interface.

The memory within the computer system may include program instructions configured to implement embodiments of an automated campaign generation system as described herein. In one embodiment, the program instructions may include software elements of embodiments of the modules discussed earlier in one of the embodiments of the automated campaign generation system. The data storage within the computer system may include data that may be used in other embodiments. In these other embodiments, other or different software elements and data may be included.

Those skilled in the art will appreciate that the computer system is merely illustrative and is not intended to limit the scope of the automated campaign generation system as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. The computer system may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from the computer system may be transmitted via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

### CONCLUSION

Various embodiments may further include receiving, sending or storing instructions and/or data implemented in accordance with the foregoing description upon a computer-accessible medium. Generally, a computer-accessible medium may include storage media or memory media such as magnetic or optical media such as disks or DVD/CD-ROM, volatile or non-volatile media such as RAM, ROM, flash drives, as well as transmission media or signals such as electrical, electromagnetic, or digital signals, conveyed via a communication medium such as network and/or a wireless link.

The various methods described herein represent example embodiments of methods. These methods may be implemented in software, hardware, or by a combination of hardware and software. The order of the method steps may be changed, and various elements may be added, reordered, combined, omitted, or modified.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

1. A computer-implemented method, comprising:
receiving, at a computing device, one or more source feeds of structured data comprising price information;
analyzing, by the computing device, the structured data to determine one or more feed elements from which to generate content;
accessing a mapping of feed elements to dynamic parameters for one or more content generation templates specified for the one or more source feeds;
for each specified content generation template, automatically generating content based on:
the template; and
the structured data according to the mapping for the corresponding template; and
providing the generated content to a search engine configured to associate the generated content with search results.

2. The computer-implemented method of claim 1, wherein said generating content further comprises automatically generating one or more keywords to be associated with the content, wherein the one or more keywords are provided to the search engine for generating the search results.

3. The computer-implemented method of claim 3, further comprising:
receiving updated structured data;
repeating the analyzing, the accessing, and the automatically generating to generate updated content based on:
the template and;
updated data from the updated structured data according to the mapping for the corresponding template; and
providing the updated content to the search engine.

4. The computer-implemented method of claim 1, wherein said providing comprises:
providing a search engine marketing system with one or more bids to associate the content with search results for specified keywords.

5. The computer-implemented method of claim 1, further comprising:
presenting the generated content for approval prior to said providing the updated content to the search engine.

6. The computer-implemented method of claim 1, wherein:
the template comprises margin information; and
the automatically generating content comprises determining a bid amount based on the price information and the margin information.

7. The computer-implemented method of claim 1, wherein the automatically generating comprises:
extracting data from the structured data according to the mapping and inserting the extracted data into locations specified by the template, wherein the template comprises pre-defined content, and wherein the template comprises instructions for generating content.

8. The computer-implemented method of claim 1, further comprising:
prior to said providing, receiving an indication to associate one or more keywords with the generated content, wherein the search engine produces the generated content in response to a search query based on at least one of the one or more keywords.

9. The computer-implemented method of claim 8, further comprising:
comparing the one or more keywords to the generated content, wherein said comparing determines a relevancy measure of the one or more keywords to the generated content;
determining a suitability score for the generated content based on the relevancy measure; and generating a warning if the suitability score is below a threshold.

10. A computer-implemented method, comprising:
receiving input via a user interface, wherein the input specifies one or more source feeds of structured data, and wherein the input specifies one or more parameter values of a template;
analyzing the structured data to determine one or more feed elements;
displaying the one or more feed elements within the user interface;
receiving mapping information via the user interface, wherein the mapping information maps each feed element to a parameter name;
displaying within the user interface, interface elements for specifying one or more parameter names within the template;
receiving the one or more parameter values of the template;
displaying within the user interface, interface elements for associating the one or more source feeds of structured data with template, wherein the template is displayed within the user interface as one of one or more templates; and
creating a computing task comprising:
a specification of the template of the one or more templates,
a specification of the one or more source feeds of structured data,
a specification of the one or more parameter values of the template,
a specification of the association of the one or more source feeds of structured data with the template, and
the mapping information, and wherein execution of the computing task generates content to provide to a search engine for association with search results.

11. A system, comprising:
a processor; and
a memory having instructions stored thereon which, when executed by the processor, cause the processor to perform operations comprising:
receive one or more source feeds of structured data comprising price information;
analyze the structured data to determine one or more feed elements from which to generate content;
access a mapping of feed elements to dynamic parameters for one or more content generation templates specified for the one or more source feeds;
for each specified content generation template, automatically generate content based on:
the template; and
data from the structured data according to the mapping for the corresponding template; and
provide the generated content to a search engine configured to associate the generated content with search results.

12. The system of claim 11, wherein the automatically generating content comprises:
automatically generate one or more keywords to be associated with the content, wherein the one or more keywords are provided to the search engine for generating the search results.

13. The system of claim 11, wherein the operations further comprise:
receive updated structured data;
repeat the analyzing, the accessing, and the automatically generating to generate updated content based on:
the template; and
updated data from the updated structured data according to the mapping for the corresponding template; and
provide the updated content to the search engine.

14. The system of claim 11, wherein the automatically generating content comprises:
provide a search engine marketing system with one or more bids to associate the content with search results for specified keywords.

15. The system of claim 11, wherein the wherein the automatically generating content comprises:
present the generated content for approval prior to the providing the updated content to the search engine.

16. A computer-readable storage medium storing program instructions, wherein the program instructions are computer-executable to implement:
receiving one or more source feeds of structured data;
analyzing the structured data to determine one or more feed elements from which to generate content;
accessing a mapping of feed elements to parameter names for one or more content generation templates specified for the one or more source feeds;
for each specified content generation template, generating content based on the template and based on data from the structured data according to the mapping for the corresponding template;
providing the generated content;
receiving updated structured data, wherein said receiving the updated structured data occurs periodically or aperiodically after said receiving the structured data;
repeating said analyzing, said accessing, and said generating to generate updated content based on the template and based on updated data from the updated structured data according to the mapping for the corresponding template, wherein said repeating occurs for each periodic or aperiodic receiving of updated structured data; and providing the generated updated content.

17. The computer-readable storage medium of claim 16, wherein said generating content further comprises automatically generating one or more keywords to be associated with the content, wherein the one or more keywords are provided to the search engine for generating the search results.

18. The computer-readable storage medium of claim 16, wherein the content and the updated content are created to be compatible with the application programming interface of a third party software application.

19. The computer-readable storage medium of claim 16, wherein said providing comprises:
providing a search engine marketing system with one or more bids to associate the content with search results for specified keywords.

20. The computer-readable storage medium of claim 16, wherein the program instructions further implement:
presenting the generated content for approval prior to said providing the updated content to the search engine.
